(19) United States
(12) Patent Application Publication
(10) Pub. No.: US 2026/0344790 A1
(43) Pub. Date: Nov. 5, 2026

(54) INDUCTIVE HEATERS FOR AN AEROSOL PROVISION DEVICE

(71) Applicant: Nicoventures Trading Limited, London (GB)

(72) Inventors: Juan Esteban Paz JAUREGUI, London (GB); Wing Siu NG, London (GB); Huihui LONG, London (GB)

(21) Appl. No.: 19/125,420

(22) PCT Filed: Oct. 31, 2023
(86) PCT No.: PCT/EP2023/080433

§ 371 Date: Apr. 29, 2025

(30) Foreign Application Priority Data
Oct. 31, 2022 (GB) 2216109.5

(51) Int. Cl. A24F 40/57; A24F 40/20; A24F 40/465; H05B 6/08; H05B 6/10

(52) U.S. Cl. CPC A24F 40/57; A24F 40/20; A24F 40/465; H05B 6/08; H05B 6/105

(57) ABSTRACT

Methods and apparatuses disclosed herein are usable to operate a resonant circuit of an inductive heater at a determined resonant frequency in a heating mode. The inductive heater can include a switching circuit and a resonant circuit, and can be used for heating a susceptor. Current flowing in the inductive heater can be measured during a heating mode, and compared to a second measurement. Based on the comparison, triggering can be controlled, and the resonant frequency determination can be updated during a sampling mode.

### CROSS-REFERENCE TO RELATED APPLICATIONS

This present application is a National Phase entry of PCT Application No. PCT/EP 2023/080433, filed 31 Oct. 2023, which claims priority from Great Britain Application No. 2216109.5, filed 31 Oct. 2022, each of which are fully incorporated herein by reference in their entireties.

### TECHNICAL FIELD

The present invention relates to a method for operating inductive heaters for an aerosol provision device and an apparatus for an aerosol provision device. The present invention also relates to an aerosol provision device, an aerosol provision system, and a method of forming an aerosol generator of an article for an aerosol provision device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use inductive heating systems as heaters to create an aerosol from a suitable medium. Induction heating systems generally comprise a magnetic field generating device for generating a varying magnetic field, and a susceptor or heating material which is heatable by penetration with the varying magnetic field to heat the suitable medium.

### SUMMARY

According to an aspect there is provided a method comprising:
(a) driving a resonant circuit of an inductive heater for an aerosol provision device at a determined resonant frequency of the resonant circuit in a heating mode, wherein the inductive heater comprises a switching circuit and a resonant circuit and wherein the inductive heater is for heating a susceptor;
(b) measuring a current flowing in the inductive heater during the heating mode;
(c) comparing a first measurement of the current to a second measurement of the current; and
(d) controlling triggering of a sampling mode based, at least in part, on the comparison in step (c), wherein the determined resonant frequency is updated during the sampling mode.

The current flowing in the inductive heater may comprise a current flowing in the resonant circuit. The current flowing in the inductive heater may comprise a current induced in the susceptor.

The first measurement of the current and the second measurement of the current may be taken at different times.

The sampling mode may be triggered at a sampling frequency. The sampling frequency may define an interval between successive sampling modes of the inductive heater.

The sampling frequency may be increased or decreased by a predetermined amount based on the comparison of step (c) of the method.

The sampling frequency may be increased or decreased by a dynamic amount based on the comparison of step (c) of the method.

Step (d) may comprise ending the heating mode. Step (d) may include ending the heating mode before triggering the sampling mode. Step (d) may further include a time delay after ending the heating mode, after which the sampling mode is started. Step (d) may further include ending the heating mode and immediately triggering the sampling mode is started.

In step (b) of the method, the first measurement of the current may be a local maximum of the current flowing in the inductive heater during the heating mode. In step (b) of the method, the second measurement of the current may be a subsequent measurement of the current flowing in the inductive heater during the heating mode. Step (c) of the method may comprise: calculating the difference between the first measurement of the current and the second measurement of the current; and comparing the difference to a threshold value.

If the magnitude of the difference between the first measurement of the current and the second measurement of the current is greater than the magnitude of a threshold value, the sampling frequency may be increased.

If the magnitude of the difference between the first measurement of the current and the second measurement of the current is smaller than the magnitude of a threshold value, the sampling frequency may be decreased.

The local maximum of the current flowing in the inductive heater during the heating mode may be determined by (e) updating the value of the local maximum each time that the resonant circuit switches from sampling mode to heating mode, to the first measured value of current flowing in the inductive heater during the heating mode. The local maximum of the current flowing in the inductive heater during the heating mode may be determined by: (f) comparing each measurement of the current to the local maximum; and (g) updating the value of the local maximum to the measured value of the current if the measured current is higher than the local maximum.

Step (c) of the method may further comprise comparing a first measurement of the current to a third measurement of the current. The first, second and third measurements of the current may be three consecutive measurements of the current.

The first, second and third measurements of the current may be taken at different times.

If the first measurement is greater than the second measurement and the third measurement, the sampling frequency may be decreased.

If the first measurement is smaller than the second measurement and/or the third measurement, the sampling frequency may be increased.

The method may further comprise (h) estimating the temperature of the susceptor from the determined resonant frequency. The method may further comprise (i) comparing the estimated temperature of the susceptor to a target temperature of the susceptor. Controlling triggering of the sampling mode in step (d) may be based, at least in part, on the comparison in step (i).

According to another aspect there is provided a controller for an inductive heater circuit for heating a susceptor comprising:
a current measurement module for measuring the current flowing in the inductive heater during the heating mode;
a first output for applying a pulse to a resonant circuit of the inductive heater circuit in a sampling mode;
a processor for comparing a first measurement of the current to a second measurement of the current;
a control module for setting a sampling frequency based, at least in part, on the comparison, wherein the sampling frequency defines an interval between successive sampling modes of the inductive heater circuit.

The controller may be further configured to carry out additional aspects of the method as described above.

According to another aspect there is provided an apparatus for an aerosol provision device comprising:
a resonant circuit comprising an inductive element and a capacitor, wherein the inductive element is for inductively heating a susceptor;
a driving circuit for applying a pulse to said resonant circuit, wherein an edge of applied pulse induces a pulse response between the capacitor and the inductive element of the resonant circuit, wherein the pulse response has a resonant frequency;
a current measurement circuit for measuring a current flowing in the inductive element; and
a processor for:
   comparing a first measurement of the current to a second measurement of the current; and
   setting a sampling frequency based, at least in part, on the comparison, wherein the sampling frequency defines an interval between successive sampling modes of the inductive heater circuit.

According to another aspect there is provided an aerosol provision device comprising the apparatus as described above.

The aerosol provision device may comprise a heating chamber for removably receiving an article comprising an aerosol generating material.

The inductive elements of the plurality of resonant circuits may be arranged along a side wall of the heating chamber. The aerosol provision device may comprise at least four inductive elements arranged along a side wall of the heating chamber.

The aerosol provision device may comprise at least five inductive elements arranged along a side wall of the heating chamber. The aerosol provision device may comprise at a grid arrangement of inductive elements arranged along a side wall of the heating chamber, for example a 2×4 grid or a 2×5 grid.

The inductive elements of the plurality of resonant circuits may be arranged along two side walls of the chamber. The inductive elements of the plurality of resonant circuits may be arranged along two opposite side walls of the chamber. The inductive elements may be arranged in two arrays, each array comprising at least four inductive elements. The inductive elements may be arranged in two arrays, each array comprising at five inductive elements.

The inductive elements may be planar coils. The inductive elements may be planar spiral inductor coils. The inductive elements may be planar non-spiral inductor coils. The inductor coil may be substantially square. The inductor coil may be substantially rectangular. The inductor coil may be trapezoidal.

The inductive elements may be disposed on a printable circuit board (PCB).

The aerosol provision device may comprise a susceptor provided within the heating chamber. The aerosol provision device may comprise two or more susceptors. The aerosol provision device may comprise a plurality of susceptors, each susceptor associated with a respective inductive element.

The inductive elements may be helical inductor coils, which surround the heating chamber

The aerosol provision device may comprise a power source. The power source may be aligned along a longitudinal axis of the heating chamber. The power source may be aligned along a second longitudinal axis, parallel to the longitudinal axis of the heating chamber.

The aerosol provision device may comprise a hinged door or removable part of an outer housing to permit access to the chamber such that a user may insert and/or remove an aerosol generating article.

The aerosol provision device may be configured for wireless charging.

According to another aspect there is provided an aerosol provision system comprising the aerosol provision device as described above, and an article comprising an aerosol generating material.

The aerosol provision device may comprise a susceptor provided within the chamber. The aerosol provision device may comprise two or more susceptors.

The article may be a cylindrical or rod shape.

The article may be substantially flat. The article may comprise a carrier component. The carrier component may comprise aerosol generating material provided on the carrier component. The aerosol generating material may be provided as a continuous layer of aerosol generating material. The aerosol generating material may be provided as a plurality of discrete portions of aerosol generating material.

The carrier component may comprise a heating layer. The carrier component may comprise a heating layer and a support layer.

The article may comprise one or more susceptor elements.

The article may comprise a single susceptor element. The single susceptor element may comprise a plurality of susceptor portions. The plurality of susceptor portions may align with a plurality of inductive heating elements provided in the aerosol provision device, when the article is inserted into the device.

The article may provide a plurality of susceptors. The plurality of susceptors may align with a plurality of inductive heating elements provided in the aerosol provision device, when the article is inserted into the device.

The aerosol provision system may further comprise a charging unit having a cavity for removably receiving the aerosol provision device.

According to another aspect there is provided a method of generating aerosol comprising: providing an aerosol provision system as described above, and at least partially inserting the aerosol generating article into the chamber.

According to a further aspect there is provided a computer program comprising instructions for causing an apparatus to perform at least the following:
(a) driving a resonant circuit of an inductive heater at a determined resonant frequency of the resonant circuit in a heating mode of operation, wherein the inductive heater comprises a switching circuit and a resonant circuit and wherein the inductive heater is for heating a susceptor
(b) comparing a first measurement of the current measured flowing in an inductive element of a resonant circuit to a second measurement of the current; and
(c) controlling triggering of a sampling mode based, at least in part, on the comparison in step (b), wherein the determined resonant frequency is updated during the sampling mode.

### BRIEF DESCRIPTION OF THE DRAWINGS

Various embodiments will now be described, by way of example only, and with reference to the accompanying drawings, in which:

FIG. 1 is a schematic representation of an apparatus for an aerosol provision device;

FIG. 2 is a flow chart outlining a method of operation of the apparatus of FIG. 1;

FIG. 3 shows a flow chart of a method of driving a resonant circuit of an inductive heater for an aerosol provision device.

FIG. 4 shows a flow chart of a method of controlling triggering of a sampling mode in a resonant circuit of an inductive heater for an aerosol provision device;

FIG. 5 shows a flow chart of a method of controlling triggering of a sampling mode in a resonant circuit of an inductive heater for an aerosol provision device;

FIG. 6 shows a schematic diagram showing the current measurements of the methods of FIGS. 3 and 4;

FIG. 7 shows a flow chart of a method of driving a resonant circuit of an inductive heater for an aerosol provision device.

FIGS. 8a and 8b are schematic views of a non-combustible aerosol provision system;

FIG. 8c is a cross-sectional view of an article comprising aerosol generating material of the aerosol provision system of FIG. 8a;

FIG. 9a shows a schematic view of another non-combustible aerosol provision system;

FIG. 9b shows a schematic view of an article comprising aerosol generating material of the aerosol provision system of FIG. 9a;

FIG. 10a shows an isometric exploded view of another aerosol provision device;

FIG. 10b shows a schematic view of an articles comprising aerosol generating material for use in the aerosol provision system of FIG. 10a;

FIG. 11a shows a schematic view of another non-combustible aerosol provision system; and

FIGS. 11b to 11e show cross-sectional views articles comprising aerosol generating material for use in the aerosol provision system of FIG. 9a.

### DETAILED DESCRIPTION

As used herein, the term “delivery mechanism” is intended to encompass systems that deliver a substance to a user, and includes: non-combustible aerosol provision systems that release compounds from an aerosolisable material without combusting the aerosolisable material, such as electronic cigarettes, tobacco heating products, and hybrid systems to generate aerosol using a combination of aerosolisable materials; and articles comprising aerosolisable material and configured to be used in one of these non-combustible aerosol provision systems.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” (which is sometimes referred to herein as an aerosolisable material) is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

In some embodiments, the substance to be delivered comprises an active substance (sometimes referred to herein as an active compound).

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film. The slurry may be heated to remove at least about 60 wt %, 70 wt %, 80 wt %, 85 wt % or 90 wt % of the solvent.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In inductive heating systems, the aerosol generator comprises a magnetic field generator, such as an inductive element and a susceptor.

A susceptor is material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise a material heatable by electrical conduction.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component.

However, in other implementations the aerosol generating article may comprise partially, or entirely, the aerosol generating component.

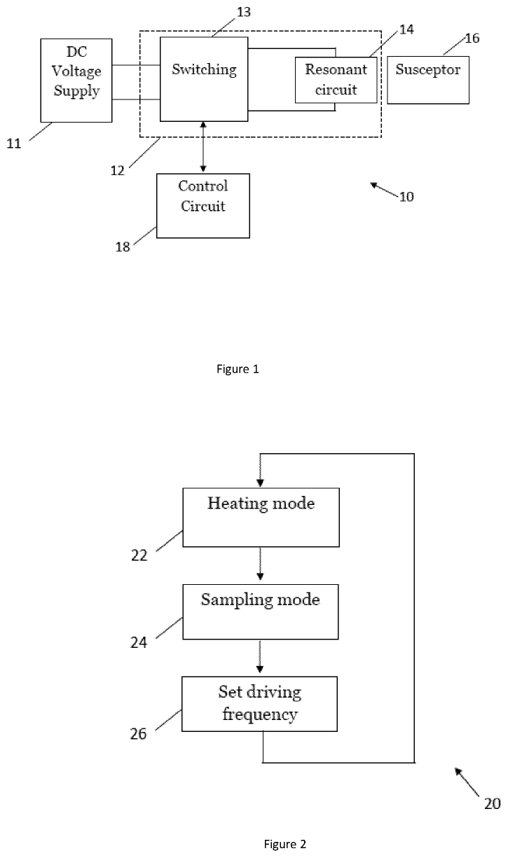

FIG. 1 is a schematic representation of an apparatus, indicated generally by the reference numeral 10, in accordance with an example embodiment. The system 10 comprises a power source in the form of a direct current (DC) voltage supply 11, a switching arrangement 13, a resonant circuit 14, a susceptor arrangement 16, and a control circuit 18. The switching arrangement 13 and the resonant circuit 14 may be coupled together in an inductive heating arrangement 12 that can be used to heat the susceptor 16.

The resonant circuit 14 may comprise one or more capacitors and one or more inductive elements for inductively heating the susceptor arrangement 16 to heat an aerosol generating material. Heating the aerosol generating material may thereby generate an aerosol.

The switching arrangement 13 may enable an alternating current to be generated from the DC voltage supply 11 (under the control of the control circuit 18). The alternating current may flow through the one or more inductive elements and may cause the heating of the susceptor arrangement 16. The switching arrangement may comprise a plurality of transistors. Example DC-AC converters include H-bridge or inverter circuits, examples of which are discussed below

FIG. 2 is a flow chart showing an algorithm, indicated generally by the reference numeral 20. The algorithm 20 may be implemented using the system 10 described above.

The algorithm 20 starts in operation 22, where a resonant circuit (e.g. the resonant circuit 14) is driven at a resonant frequency of the resonant circuit in a heating mode of operation. For example, the switching arrangement 13 may be switched at a determined resonant frequency of the resonant circuit 14 (under the control of the control circuit 18). In this embodiment, the resonant circuit is driven at a predetermined starting resonant frequency.

In an alternative embodiment, the algorithm may start at operation 24, where the sampling mode is triggered prior to heating for the first time, in other words the sampling mode pings the susceptor prior to heating. The sampling mode determines frequency to start heating at.

At operation 24, a sampling mode of operation is entered. The sampling mode may seek to determine the resonant frequency for use in the heating mode (e.g. during the next iteration of the algorithm 20). The sampling mode may include applying a pulse to the resonant circuit at a specified time interval and processing the resonant response to determine/estimate the resonant frequency.

At operation 26, the driving frequency for the resonant circuit is set based on the determined resonant frequency.

Thus, the parameters of the heating mode (including the driving frequency and the sampling interval) are set in the operation 26. The heating of the susceptor occurs in the next iteration of the heating mode 22 until the time interval dictated by the sampling mode occurs. The algorithm 20 then re-enters the sampling mode 24 where the resonant frequency of the resonant circuit is again determined and the parameters of the heating and sampling modes are updated (in the operation 26).

A controller (which may be part of the control circuit 18) may be used to determine how often to initiate the sampling mode 24. The controller may seek to strike a balance between sampling sufficiently often to ensure that the resonant circuit is being driven at (or close to) its resonant frequency in the heating mode 22 (thereby tending to increase heating efficiency) and having a low sampling rate (i.e. a high sampling period) so that the susceptor spends a large proportion of its time being heated (again, tending to increase heating efficiency).

The sampling period (i.e. how often the sampling mode 24 is entered) may be a controllable variable. As discussed in detail below, there are a number of mechanisms that could be used for setting the sampling period (e.g. relating to a heating temperature, heating current, or both).

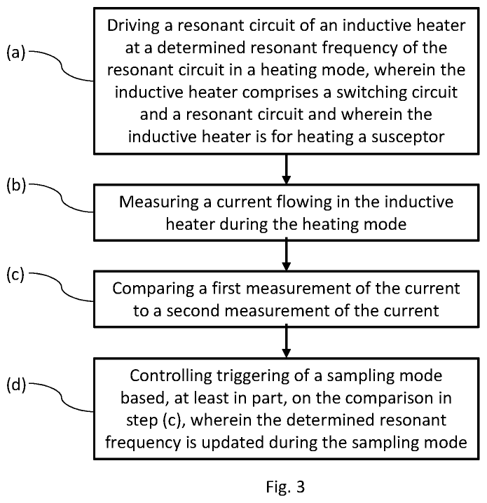

FIG. 3 is a flow chart of a method in accordance with an example of the present disclosure. The method of FIG. 3 describes the sampling mode of FIG. 2. The method of FIG. 3 includes the steps of: (a) driving a resonant circuit of an inductive heater at a determined resonant frequency of the resonant circuit in a heating mode, wherein the inductive heater comprises a switching circuit and a resonant circuit and wherein the inductive heater is for heating a susceptor; (b) measuring a current flowing in the inductive heater during the heating mode; (c) comparing a first measurement of the current to a second measurement of the current; and (d) controlling triggering of a sampling mode based, at least in part, on the comparison in step (c), wherein the determined resonant frequency is updated during the sampling mode.

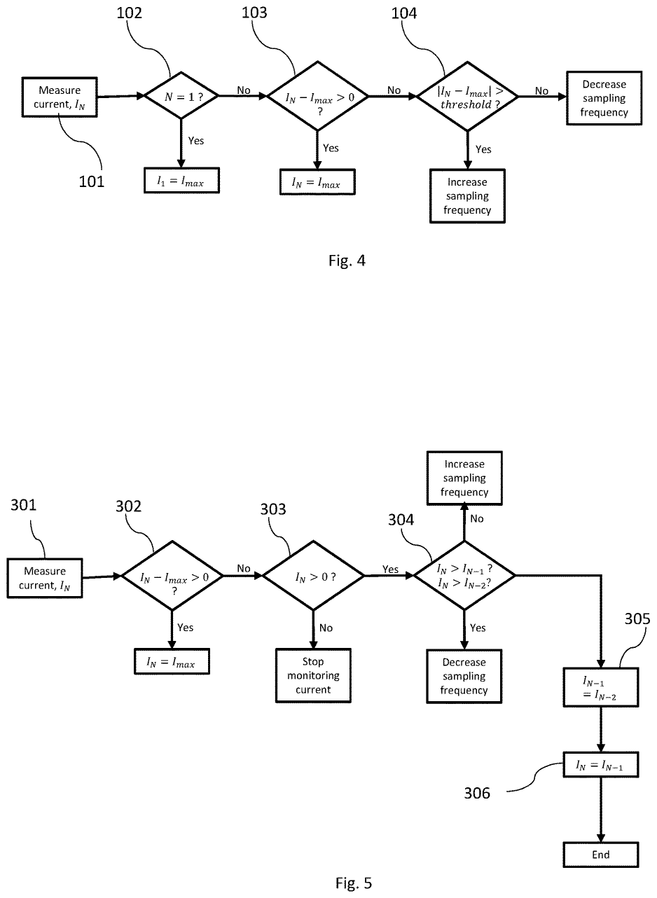

FIGS. 4 and 5 describe in more detail, example embodiments of the triggering of the sampling mode as shown in FIG. 3

According to the step (a) of the method of FIG. 3, the resonant circuit (for example as described above) is being operated in a heating mode. The heating mode involves driving the resonant circuit of an inductive heater at a determined resonant frequency of the resonant circuit.

According to step 101 of FIG. 4 (which corresponds to step (b) of FIG. 3), the current flowing in the inductive heater during the heating mode is measured. The current may be measured at any suitable point in the resonant circuit. In some examples, the current may be measured from a connection to an inductive component and/or a capacitive component.

The current flowing in the inductive heater may comprise a current flowing in the resonant circuit. The current flowing in the inductive heater may comprise a current induced in the susceptor.

Steps 102 to 104 of FIG. 4 correspond to steps (c) and (d) of FIG. 3.

According to step (c) of the method, a first measurement of the current is compared to a second measurement of the current. In some examples, the first measurement of the current and the second measurement of the current are taken at different times. In this example, the first measurement of the current is a local maximum of the current flowing in the inductive heater during the heating mode and the second measurement of the current is a subsequent measurement of the current flowing in the inductive heater during the heating mode.

The current flowing in the inductive heater during the heating mode is maximised when the inductive heater is operating at its resonant frequency. The inductive heater may be most effective at its resonant frequency. Therefore, in order to bring the inductive heater to the desired temperature effectively (e.g. reducing the time taken and/or reducing the power required), it may be advantageous to monitor the current. In particular, it may be advantageous to compare the current to a maximum value of the current (Iₘₐₓ) , to help determine whether the inductive heater is operating at its resonant frequency.

Furthermore, the resonant frequency depends upon the temperature of the inductive heater. As the temperature of the inductive heater increases (e.g. during a heating mode), the resonant frequency of the inductive heater decreases.

Therefore, it may be advantageous to update the value of the maximum current over time (e.g. as the temperature of the inductive heater increases over time).

In FIG. 4, after each measurement of the current at step 101, the method proceeds to step 102.

In step 102, it is determined whether the measurement of the current is the first measurement taken since the heating mode began. If it is the first measurement of current taken since the heating mode began, then this value is set as the local maximum of the current.

In another embodiment, the local maximum of the current Iₘₐₓ as determined in the previous heating cycle is retained and used. This provides a maximum target value and may result in faster heating. The local maximum of the current Iₘₐₓ as determined in any previous heating cycle may be retained and used.

The method then proceeds to step 103 of FIG. 3. In step 103, the difference between the measurement of the current I_{N} and the local maximum Iₘₐₓ of the current is calculated. It is then determined whether the difference between the measurement of the current I_{N} and the local maximum of the current Iₘₐₓ is greater than zero. If the difference is greater than zero, this indicates that the measurement of current is larger than the local maximum current Iₘₐₓ . Hence, the value of the local maximum current is updated to that value.

If the difference is less than zero, this indicates that the measurement of current is smaller than the local maximum current Iₘₐₓ , and therefore the current flowing through the circuit is falling over time. This may indicate that the inductive heater is no longer being operated at its resonant frequency. In some examples, this may indicate that the resonant frequency has changed, for example, owing to the temperature of the inductive heater changing (e.g. increasing).

If the difference is less than zero, then the method proceeds to step 104. In step 104, the difference between the measurement of the current and the local maximum of the current Iₘₐₓ is compared to a threshold value. The threshold value may be any desired value.

If the magnitude of the difference between the measurement of the current and the local maximum of the current is greater than the magnitude of a threshold value, the sampling frequency is increased. If it is determined that the current is changing by a significant amount (i.e. an amount that is larger than the threshold value), then this indicates that the resonant frequency of the inductive heater may have changed by a significant amount. This may also indicate that the temperature of the inductive heater may have changed by a significant amount.

Therefore, it may be advantageous to increase the frequency at which the sampling mode is triggered. During the sampling mode, the determined resonant frequency is updated (e.g. by measurement of the resonant frequency). By measuring the resonant frequency more often, any changes may be detected sooner and the operation of the inductive heater may be adjusted accordingly.

At step 104, if the magnitude of the difference between the measurement of the current and the local maximum of the current is smaller than the magnitude of a threshold value, the sampling frequency is decreased. If it is determined that the current has not changed by a significant amount, then this indicates that the resonant frequency of the inductive heater may be substantially constant over time. This may also indicate that the temperature of the inductive heater may not have changed by a significant amount.

Therefore, it may be advantageous to decrease the frequency at which the sampling mode is triggered. During the sampling mode, the determined resonant frequency is updated (e.g. by measurement of the resonant frequency). As there is no indication that the resonant frequency has changed, this measurement may be avoided. This may be advantageous because the heating mode may need to be paused to update the determined resonant frequency (e.g. in order to measure the resonant frequency). Pausing the heating mode may increase the time that it takes for the inductive heater to reach a desired temperate. Therefore, avoiding a measurement of the resonant frequency if there is no indication that it is required may help to decrease the time required for the indictive heater to reach a desired temperature.

The sampling frequency may be increased and/or decreased in any manner. In some examples, the sampling frequency may be increased or decreased by a predetermined amount (e.g. each time that the comparison of step 104 is made). In some examples, the sampling frequency may be increased or decreased by more than 50 Hz, optionally more than 100 Hz, optionally more than 200 Hz, optionally more than 500 Hz. In a preferred embodiment, the sampling frequency may be increased or decreased by approximately 200 Hz (e.g. each time that the comparison of step 104 is made).

In some examples, the sampling frequency may be increased or decreased by a dynamic (i.e. non-predetermined) amount. In some examples, the amount by which the sampling frequency is increased or decreased may depend on the magnitude of the difference between the measurement of the current and the local maximum of the current. For example, the amount by which the sampling frequency is increased or decreased may be proportional to the difference between the measurement of the current and the local maximum of the current. For example, if the current has changed by a large amount, this may indicate that the resonant frequency and/or the temperature is changing quickly, meaning that frequent sampling may be advantageous. Alternatively, if the current has changed by a small amount, this may indicate that the resonant frequency and/or the temperature is changing slowly, meaning that such frequent sampling may not be required.

### FIG. 5 is a method according to another embodiment

According to the step (a) of the method, the resonant circuit (not shown) is being operated in a heating mode. The heating mode involves driving the resonant circuit of an inductive heater at a determined resonant frequency of the resonant circuit.

The method of FIG. 5 starts at step 301 with a measurement of the current flowing in the inductive heater. The current may be measured at any suitable point in the resonant circuit. In some examples, the current may be measured from a connection to an inductive component and/or a capacitive component.

Steps 302 to 304 of FIG. 5 correspond to steps (c) and (d) of FIG. 3.

At step 302, the measurement of the current is compared to a local maximum value of the current Iₘₐₓ.

The local maximum value of the current Iₘₐₓ , may be determined as shown in FIG. 4, or may be the local maximum of the current Iₘₐₓ as determined in the previous heating cycle is retained and used. The local maximum of the current Iₘₐₓ as determined in any previous heating cycle may be retained and used.

If the measurement of the current is larger than the local maximum value, then the local maximum is updated.

The method then proceeds to step 303, where it is determined whether the value of the current is greater than zero. If the current flowing through the inductive heater is zero, this indicates that the inductive heater is no longer in the heating mode (e.g. that the inductive heater has been switched off), and hence there is no requirement to monitor the current at that time.

If the value of the current is greater than zero, this indicates that the inductive heater is in the heating mode. Therefore, the method proceeds to step 304. At step 304, the value of the current determined from the measurement of the current is compared to the (stored) values of the current determined from the two previous measurements of the current.

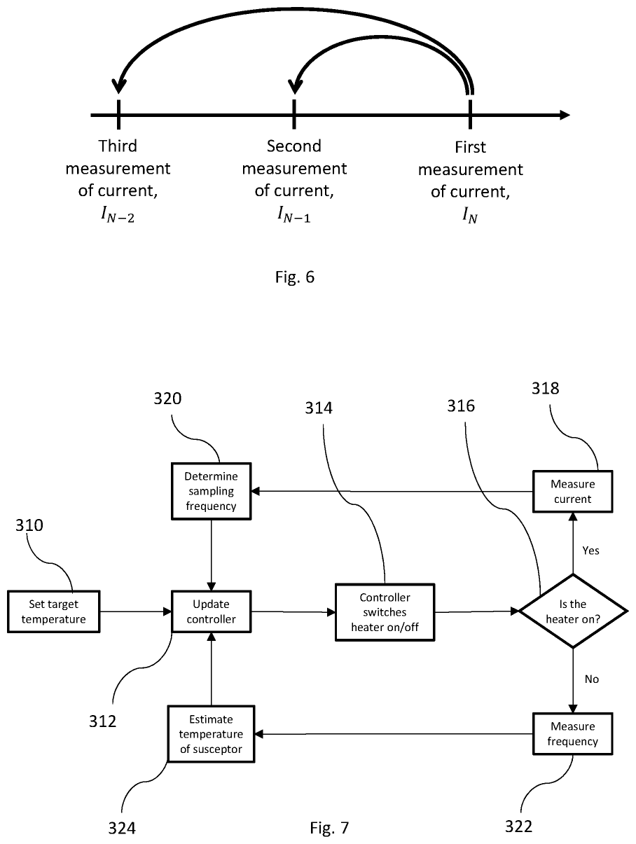

In the example of FIG. 5, the most recent measurement of current is referred to as the ‘first measurement of current’. The second most recent measurement of current is referred to as the ‘second measurement of current’, and the third most recent measurement of current is referred to as the ‘third measurement of current’. This is illustrated in FIG. 6. As shown in FIG. 6, the first measurement of current is compared to both the second and third measurements of current.

If the measurement of the current is greater than both of the previous two measurements of the current, the sampling frequency is decreased.

If it is determined that the current is increasing, then this may indicate that the frequency is moving towards, but may not yet have reached, the resonant frequency of the inductive heater. Therefore, it may be advantageous to decrease the frequency at which the sampling mode is triggered. As there is no indication that the resonant frequency has changed, this measurement may be avoided. This may be advantageous because the heating mode may need to be paused to update the determined resonant frequency (e.g. in order to measure the resonant frequency). Pausing the heating mode may increase the time that it takes for the susceptor and/or inductive heater to reach a desired temperature Therefore, avoiding a measurement of the resonant frequency if there is no indication that it is required may help to decrease the time required for the susceptor and/or inductive heater to reach a desired temperature.

If the measurement of the current is smaller than one or both of the previous two measurements of the current, the sampling frequency is increased.

If it is determined that the current is decreasing, then this may indicate that the frequency of the inductive heater is off resonance (This may also indicate that the temperature of the susceptor and/or inductive heater may have increased.

Therefore, it may be advantageous to increase the frequency at which the sampling mode is triggered. During the sampling mode, the determined resonant frequency is updated (e.g. by measurement of the resonant frequency). By measuring the resonant frequency more often, any changes may be detected sooner and the operation of the inductive heater may be adjusted accordingly.

The sampling frequency may be increased and/or decreased in any manner. In some examples, the sampling frequency may be increased or decreased by a predetermined amount (e.g. each time that the comparison of step 304 is made). In some examples, the sampling frequency may be increased or decreased by more than 50 Hz, optionally more than 100 Hz, optionally more than 200 Hz, optionally more than 500 Hz. In a preferred embodiment, the sampling frequency may be increased or decreased by approximately 200 Hz (e.g. each time that the comparison of step 104 is made).

In some examples, the sampling frequency may be increased or decreased by a dynamic (i.e. non-predetermined) amount. In some examples, the amount by which the sampling frequency is increased or decreased may depend on the magnitude of the difference between the measurement of the current and the local maximum of the current. For example, the amount by which the sampling frequency is increased or decreased may be proportional to the difference between the measurement of the current and the local maximum of the current. For example, if the current has changed by a large amount, this may indicate that the resonant frequency and/or the temperature is changing quickly, meaning that frequent sampling may be advantageous. Alternatively, if the current has changed by a small amount, this may indicate that the resonant frequency and/or the temperature is changing slowly, meaning that such frequent sampling may not be required.

At steps 305 and 306, the stored values of the current are reset for the next measurement. Hence, the first measurement of the current becomes stored as the second measurement of the current and the second measurement of the current becomes stored as the third measurement of the current. Therefore, when the next measurement of the current is taken, the previous two values are stored for the comparison in step 304.

FIG. 7 is a method according to an example of the present disclosure. In this example, the method includes the steps of estimating the temperature of the susceptor from the determined resonant frequency and comparing the estimated temperature of the susceptor to a target temperature of the susceptor. Controlling triggering of the sampling mode is based, at least in part, on this comparison.

In step 310, the target temperature is set. The target temperature may be set in any way. In some examples, the target temperature is the desired operational temperature of the susceptor. In step 312, the controller is updated with the target temperature that has been set in step 310.

In step 314, the controller switches the heater on or off. When the heater is switched on, the heater may be configured to operate in the heating mode.

In step 316, it is determined whether the heater is on. If the heater is on, the method proceeds to steps 318 and 320. In step 318, the current is measured and in step 320 the sampling frequency is determined. The sampling frequency may be determined using any of the methods set out above. In particular, the sampling frequency may be determined at least in part based on the current measured in step 318.

If, at step 316, it is determined that the heater is off, the method proceeds to steps 322 and 324. In step 322, the frequency is measured and in step 324 the temperature of the susceptor is estimated. The estimated temperature of the susceptor may be determined using any suitable technique. In particular, the estimated temperature of the susceptor may be based at least in part on the frequency measured in step 322.

After the sampling frequency has been determined in step 318 or the temperature of the susceptor has been estimated in step 324, the method proceeds to step 312. In step 312, the controller is updated with either the determined sampling frequency or the estimated temperature of the susceptor. This ensures that the controller is able to control the heater with the updated information. In particular, the controller may control triggering of the sampling mode based on the feedback received in step 312.

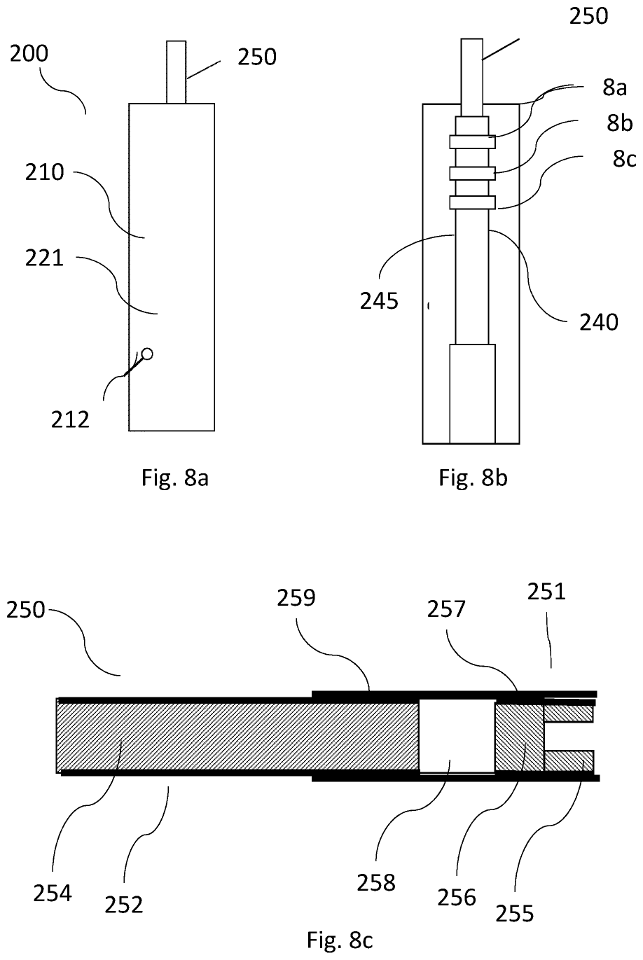

FIGS. 8 to 11 show non-combustible aerosol provision devices and systems which may be controlled in accordance with the principles described herein.

FIG. 8a is a perspective illustration of an aerosol provision system 200 comprising an aerosol provision device 210 with an outer housing 221 and a replaceable article 250 (also known as a consumable) that may be inserted in the aerosol provision device 210. The aerosol provision device 210 may further comprise an activation switch 212 that may be used for switching on or switching off the aerosol provision device 220. In other embodiments, the device does not include an activation switch 212 is provided and a pressure trigger or some other activation-on-demand arrangement may be provided.

FIG. 8b shows the aerosol provision system 200 with a front portion of the outer housing removed. The aerosol generating device 210 comprises a plurality of inductive heaters (also referred to as inductive heater units) 8a, 8b, 8c surrounding a heating chamber 240 into which a distal end of the article 250 is inserted.

The plurality of inductive heaters 8a-c comprise a resonant circuit, such as the resonant circuit 14 described above. In other words, the aerosol provision device 210 comprises a plurality of resonance circuits as described above.

The or each inductive heater units 8a-c may comprise an inductive element 9 such as a helical inductor coil. In one example, the helical inductor coil is made from Litz wire/cable which is wound in a helical fashion to provide the helical inductor coil. In other embodiments, other types are inductor elements are provided, as inductors formed within a printed circuit board. The inductive heater units and inductive element provided therein may be the same or similar. The use of three inductive heater units is not essential to all example embodiments.

Thus, the aerosol generating device 210 may comprise one or more inductive heaters. In other embodiments, the device 210 may include four or more helical coil inductive elements.

The aerosol provision system 200 includes a susceptor 245 provided within the heating chamber 240, such that when the article is inserted into the heating chamber 240 and at least partially surrounded by the susceptor.

In use, the article 250 is received in the article chamber 240. The inductive elements 9a-c surrounds the susceptor 245. The inductive elements 9a-c induce a varying magnetic field in the susceptor 245, which causes heating of the susceptor 245. The susceptor 245 in turn heats aerosol generating material in the article 250.

FIG. 8c shows an embodiment of an article 250 for use in an aerosol provision device 210 as described above, having a susceptor provided in the device. The article 250 comprises a mouthpiece 251, and a cylindrical rod of aerosol generating material 254 connected to the mouthpiece 251. The aerosol generating material 233 is wrapped in a wrapper 252. The wrapper 232 can, for instance, be a paper or paper-backed foil wrapper. The wrapper 232 may be substantially impermeable to air. In one embodiment, the wrapper 232 comprises aluminium foil.

The mouthpiece 251, in the present example, includes a body of material 256 upstream of a hollow tubular element 255, in this example adjacent to and in an abutting relationship with the hollow tubular element 255. The body of material 256 and hollow tubular element 255 each define a substantially cylindrical overall outer shape and share a common longitudinal axis. The body of material 256 is wrapped in a first plug wrap 257. The mouthpiece 251 also includes a second hollow tubular element 258, also referred to as a cooling element, upstream of the first hollow tubular element 254. The body of material 256 and second hollow tubular element 258 each define a substantially cylindrical overall outer shape and share a common longitudinal axis. The second hollow tubular element 258 is formed from a plurality of layers of paper which are parallel wound, with butted seams, to form the tubular element 258. A second plug wrap 259 is also provided around the mouthpiece 251.

The aerosol generating material 254, also referred to herein as an aerosol generating substrate 254, comprises at least one aerosol forming material. In the present example, the aerosol forming material is glycerol. In alternative examples, the aerosol forming material can be another material as described herein or a combination thereof. The aerosol generating substrate may comprise botanical material, for example tobacco.

In alternative embodiment, the susceptor 245 may be provided in the article 250, for example embedded in the aerosol generating material 254.

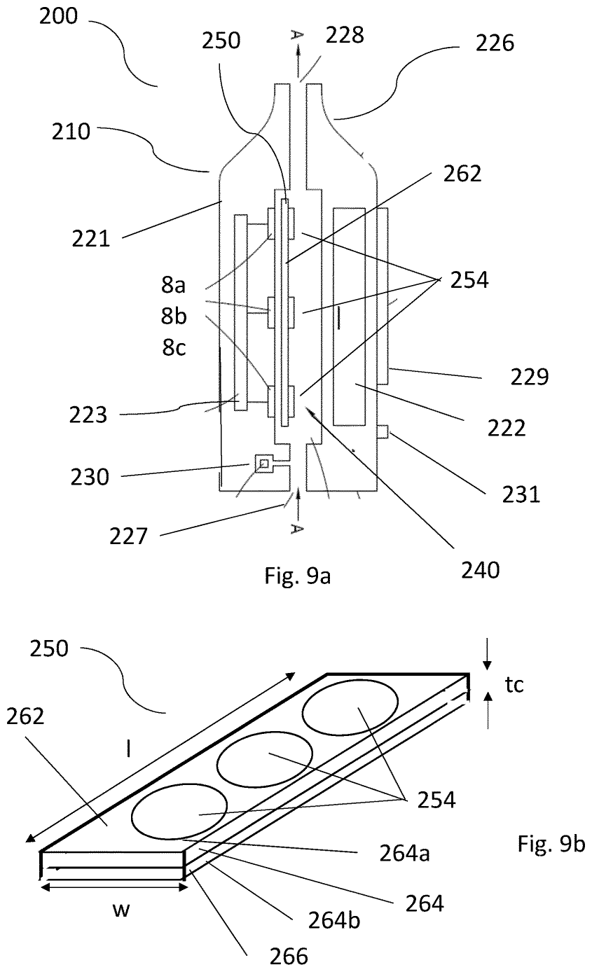

FIG. 9a is a cross-sectional view through a schematic representation of an aerosol provision system 200 in accordance with another embodiment. The aerosol generating system 200 comprises an aerosol provision device 210 and an aerosol generating article 250.

The aerosol provision device 210 comprises an outer housing 221, a power source 222, control circuitry 223, a plurality of inductive elements 8a-8c, a chamber 240, a mouthpiece end 226, an air inlet 227, an air outlet 228, a touch-sensitive panel 229, an inhalation sensor 230, and an end of use indicator 231.

The plurality of inductive heaters 8a-c comprise a resonant circuit, such as the resonant circuit 14 described above. In other words, the aerosol provision device 210 comprises a plurality of resonance circuits as described above.

The inductive elements 8a-8c may comprise any suitable inductive element, such as but not limited to a substantially planar inductor coil.

The outer housing 221 may be formed from any suitable material, for example a plastics material. The outer housing 221 is arranged such that the power source 222, control circuitry 223, aerosol generating components 224, chamber 240 and inhalation sensor 230 are located within the outer housing 221. The outer housing 221 also defines the air inlet 227 and air outlet 228, described in more detail below. The touch sensitive panel 229 and end of use indicator are located on the exterior of the outer housing 221. The outer housing 221 and mouthpiece end 226 are formed as a single component (that is, the mouthpiece end 226 forms a part of the outer housing 221). In other embodiments, the mouthpiece end 226 may be a removable component that is separate from but able to be coupled to the outer housing 221, and may be removed for cleaning and/or replacement with another mouthpiece end 226.

The chamber 240 is suitable sized to removably receive the aerosol generating article 250 therein. Although not shown, the aerosol provision device 210 may comprise a hinged door or removable part of the outer housing 221 to permit access to the chamber 240 such that a user may insert and/or remove the aerosol generating article 250 from the chamber 240 The hinged door or removable part of the outer housing 210 may also act to retain the aerosol generating article 250 within the chamber 250 when closed. Alternatively, the aerosol provision device 210 may include a permanent opening that communicates with the chamber 240 and through which the aerosol generating article 250 can be inserted into the chamber 240. In such implementations, a retaining mechanism for retaining the aerosol generating article 250 within the chamber 240 of the aerosol provision device 210 may be provided.

The power source 222 is configured to provide operating power to the aerosol provision device 210. The power source 222 may be any suitable power source, such as a battery. For example, the power source 222 may comprise a rechargeable battery, such as a Lithium Ion battery. The power source 222 may be removable or form an integrated part of the aerosol provision device 210. In some implementations, the power source 222 may be recharged through connection of the aerosol provision device 210 to an external power supply (such as mains power) through an associated connection port, such as a USB port (not shown) or via a suitable wireless receiver (not shown).

The control circuitry 223 is suitably configured/programmed to control the operation of the aerosol provision device to provide certain operating functions of aerosol provision device 210. The control circuitry 223 is connected to the power supply 23 and receives power from the power source 222 and may be configured to distribute or control the power supply to other components of the aerosol provision device 210.

The aerosol provision device 210 further comprises a chamber 240 which is arranged to receive an aerosol generating article 250. The aerosol generating article comprises a carrier component 262 and aerosol generating material 254 (for example an aerosol generating film) provided on or within a surface of the carrier 262. The article 250 further comprises a susceptor material (not shown in FIG. 7a).

The inductive elements 8a-c may be referred to as heating elements. The inductive elements 8a-8c are aligned along an axis parallel to a longitudinal axis of the device 210. Each inductive element aligns with a corresponding discrete portion of aerosol generating material 254, defining a respective aerosol generating region.

In some implementations, to improve the heat-transfer efficiency, the chamber may comprise components which apply a force to the surface of the carrier component 262 so as to press the carrier component 262 onto the inductive elements 8a-c, thereby increasing the efficiency of heat transfer via conduction to the aerosol generating material 254.

In other embodiments four or more inductive elements may be provided aligned along an axis parallel to the longitudinal axis of the device 210.

FIG. 9b shows a schematic view of the article 250 from FIG. 9a. The carrier component 262 is broadly cuboidal in shape has a length I, a width w and a thickness tc.

The aerosol generating article 250 comprises a plurality of discrete portions of aerosol generating material 254 disposed on a surface of the carrier component 262. The discrete portions of aerosol generating material 254 are separate from one another such that each of the discrete portions may be energised (e.g. heated) individually or selectively to produce an aerosol. The aerosol generating article 250 may comprise a plurality of portions of aerosol generating material all formed form the same aerosol generating material. Alternatively, the aerosol generating article 250 may comprise a plurality of portions of aerosol generating material 254 where at least two portions are formed from different aerosol generating material.

In this embodiment, the aerosol generating article 250 comprises three discrete portions of aerosol generating material 254, aligned along a central axis Xc of the article in order to align with the inductive elements in the device 210. In other embodiments, a greater or lesser number of discrete portions may be provided, and/or the portions may be disposed in a different pattern so as to align with any arrangement of inductive elements in the aerosol provision device.

The carrier layer 262 comprises a heating layer 264 which acts as the susceptor 245 and a support layer 266. The aerosol generating material 254 is provided on a first side 264a of the heating layer 264. The aerosol generating material 254 is divided into the discrete portions which may be easily sequentially heated (e.g. one by one) during an aerosol generation session.

In the present example, the heating layer 264 is formed of an aluminium foil material. In other examples, the heating layer 264 may be formed of a different material, for example another metal or a metal alloy.

The support layer 266 is provided on a second side 264b of the heating layer 264. The support layer 266 comprises a single layer of material. The support layer 266 is formed entirely of the same material. In the present example, the support layer 266 is formed of paper or cardboard. The support layer 266 provides structural support to the heating layer 246. The support layer 266 provides structural support to the article 250.

In other embodiments, the article comprises a continuous layer of aerosol generating material provided on the carrier component 262.

In other embodiments, the carrier component 262 may comprise a single layer which is a heating layer 264 which acts as the susceptor 245.

In use, the article 250 is received in the article chamber 240. The inductive elements 8 surrounds the susceptor 245. The inductive elements 8 induce a varying magnetic field in the susceptor 245, which causes heating of the susceptor 245. The susceptor 245 in turn heats aerosol generating material in the article 250.

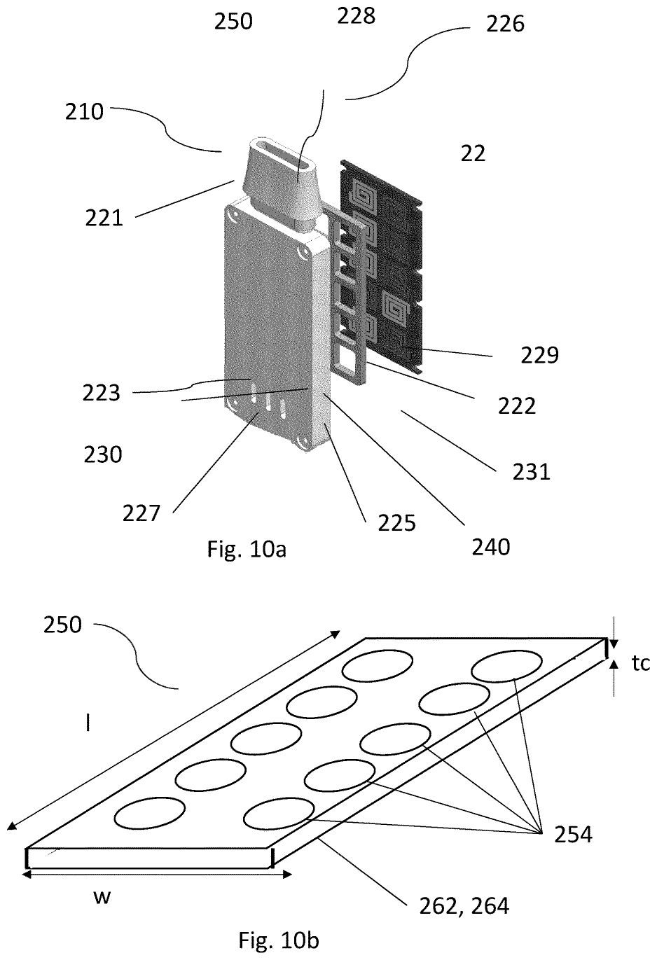

FIG. 10a shows an isometric exploded view of an aerosol provision device 210 in accordance with another embodiment. The aerosol provision device 210 includes components that are broadly similar to those described in relation to FIG. 6a, the same reference numbers are used and they should be understood to be broadly the same as their counterparts unless otherwise stated. The aerosol provision device 210 comprises a plurality of resonance circuits as described above.

The device 210 comprises a plurality of inductive elements 8, which in this example are in a 2×5 configuration. The plurality of inductive heaters 8a-c comprise a resonant circuit, such as the resonant circuit 14 described above. In this embodiment, the device 210 includes a plurality of air inlet holes 227 and air transmission channels 237 to direct air to the inductive elements 8.

In another embodiment (not shown), each of the plurality of inductive elements 8 enclosed by the respective aerosol transmission channels have an individual air supply hole. It will be appreciated that in other embodiments, the device can have a single air inlet (as described previously).

FIG. 10b shows an article 250 in accordance with another embodiment for use with the device of FIG. 8a. The article 250 includes components that are broadly similar to those described in relation to FIG. 9b, the same reference numbers are used and they should be understood to be broadly the same as their counterparts unless otherwise stated. In FIG. 10b, the article 250 includes ten discrete portions of aerosol generating material 254 provided on a first side 254a of a carrier component 262. The discrete portions are provided in a 2×5 grid. In this embodiment, the carrier component 262 comprises a heating layer 264.

It will be appreciated that in other embodiments, the carrier component 262 also includes a support layer.

In other embodiments, aerosol provision devices may be provided with any number of inductive elements may be provided in alternative grid configuration, for example a 2×3 grid, a 2×4 grid or a 3×3 grid.

In alternative embodiments, aerosol generating articles may be provided with the aerosol generating material 254 may be distributed in a different number of discrete portions and in different locations on the first side of the heating layer 264 as required.

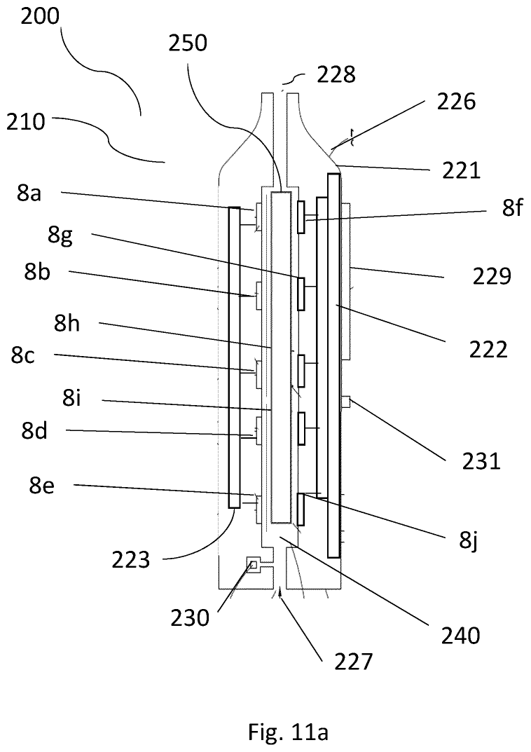

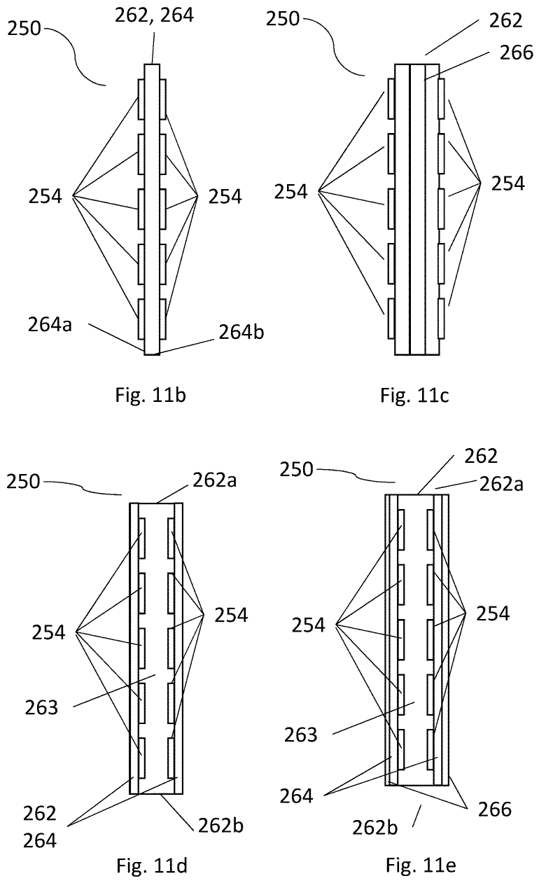

FIG. 11a shows an aerosol provision system 200 in accordance with another embodiment. The aerosol provision device 210 includes components that are broadly similar to those described in relation to FIG. 9a, the same reference numbers are used and they should be understood to be broadly the same as their counterparts unless otherwise stated.

The aerosol provision device 210 comprises a plurality of resonance circuits as described above. The device 210 comprises a plurality of inductive elements 8, which in this embodiment are provided in a first array 8a to e and a second array 8f to 8j. The first array of inductive elements 8a to 8e is provided on a first side of the chamber 240 and the second array 8f to 8j is provided on a second, opposite side of the chamber 240.

In other embodiments, the aerosol provision device 210 may comprise a hinged door or removable part of the outer housing 221 to permit access to the chamber 240 such that a user may insert and/or remove the aerosol generating article 250 from the chamber 240.

FIG. 11b to we show various articles which can be used with the device of FIG. 11a. The articles are broadly cuboidal in shape so as to be received in the chamber 240 of the device 210.

FIG. 11b shows a cross-sectional view through an article 250 comprising a carrier component 262 comprising a heating layer 264. Discrete portions of aerosol generating material 254 are provided on a first side 264a and a second side 264b of the heating layer 264.

FIG. 11c shows a cross-sectional view through an article 250 comprising a carrier component 262 comprising a support layer 266 and two heating layers 264, wherein the support layer is provided between the heating layers 264. Discrete portions of aerosol generating material 254 are provided on outer surfaces of of the heating layers 264.

FIG. 11d shows a cross-sectional view through an article 250 comprising a substantially cuboidal carrier component 262. The article defines an inner void 263 having with open first and second ends 262a, 262b. The carrier component 262 comprises a heating layer 264 provided on opposition sides of the inner void.

Discrete portions of aerosol generating material 254 are provided inner surfaces of the heating layers 264.

FIG. 11e shows a cross-sectional view through an article 250 comprising a substantially cuboidal carrier component 262. The article defines an inner void 263 having with open first and second ends 262a, 262b. The carrier component 262 comprises a heating layer 264 and a support layer 266. Discrete portions of aerosol generating material 254 are provided on inner surfaces of the heating layer 264.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A method comprising:
(a) driving a resonant circuit of an inductive heater for an aerosol provision device at a determined resonant frequency of the resonant circuit in a heating mode, wherein the inductive heater comprises a switching circuit and a resonant circuit and wherein the inductive heater is for heating a susceptor;
(b) measuring a current flowing in the inductive heater during the heating mode;
(c) comparing a first measurement of the current to a second measurement of the current; and
(d) controlling triggering of a sampling mode based, at least in part, on the comparison in step (c), wherein the determined resonant frequency is updated during the sampling mode.

2. The method of claim 1, wherein the first measurement of the current and the second measurement of the current are taken at different times.

3. The method of claim 1, wherein the sampling mode is triggered at a sampling frequency, wherein the sampling frequency defines an interval between successive sampling modes of the inductive heater.

4. The method of claim 3, wherein the sampling frequency is increased or decreased by a predetermined amount based on the comparison of step (c) of the method.

5. The method of claim 3, wherein the sampling frequency is increased or decreased by a dynamic amount based on the comparison of step (c) of the method.

6. The method of claim 1, wherein triggering the sampling mode comprises ending the heating mode.

7. The method of claim 1, wherein in step (b) of the method:
the first measurement of the current is a local maximum of the current flowing in the inductive heater during the heating mode; and
the second measurement of the current is a subsequent measurement of the current flowing in the inductive heater during the heating mode; and
wherein step (c) of the method comprises:
calculating the difference between the first measurement of the current and the second measurement of the current; and
comparing the difference to a threshold value.

8. The method of claim 7, wherein, if the magnitude of the difference between the first measurement of the current and the second measurement of the current is greater than the magnitude of a threshold value, the sampling frequency is increased.

9. The method of claim 7 wherein, if the magnitude of the difference between the first measurement of the current and the second measurement of the current is smaller than the magnitude of a threshold value, the sampling frequency is decreased.

10. The method of claim 7, wherein the local maximum of the current flowing in the inductive heater during the heating mode is determined by:
(e) updating the value of the local maximum each time that the resonant circuit switches from sampling mode to heating mode, to the first measured value of current flowing in the inductive heater during the heating mode;
(f) comparing each measurement of the current to the local maximum; and
(g) updating the value of the local maximum to the measured value of the current if the measured current is higher than the local maximum.

11. The method of claim 1, wherein step (c) of the method further comprises:
comparing a first measurement of the current to a third measurement of the current;
wherein the first, second and third measurements of the current are three consecutive measurements of the current.

12. (canceled)

13. The method of claim 11, wherein if the first measurement is greater than the second measurement and the third measurement, the sampling frequency is decreased.

14. The method of claim 11, wherein if the first measurement is smaller than the second measurement and/or the third measurement, the sampling frequency is increased.

15. The method of claim 1, wherein the method further comprises:
(h) estimating the temperature of the susceptor from the determined resonant frequency; and
(i) comparing the estimated temperature of the susceptor to a target temperature of the susceptor;
wherein controlling triggering of the sampling mode in step (d) is based, at least in part, on the comparison in step (i).

16. A controller for an inductive heater circuit for heating a susceptor comprising:
a current measurement module for measuring the current flowing in the inductive heater during the heating mode;
a first output for applying a pulse to a resonant circuit of the inductive heater circuit in a sampling mode;
a processor for comparing a first measurement of the current to a second measurement of the current;
a control module for setting a sampling frequency based, at least in part, on the comparison, wherein the sampling frequency defines an interval between successive sampling modes of the inductive heater circuit.

17. An apparatus for an aerosol provision device comprising:
a resonant circuit comprising an inductive element and a capacitor, wherein the inductive element is for inductively heating a susceptor;
a driving circuit for applying a pulse to said resonant circuit, wherein an edge of applied pulse induces a pulse response between the capacitor and the inductive element of the resonant circuit, wherein the pulse response has a resonant frequency;
a current measurement circuit for measuring a current flowing in the inductive element; and
a processor for:
comparing a first measurement of the current to a second measurement of the current; and
setting a sampling frequency based, at least in part, on the comparison, wherein the sampling frequency defines an interval between successive sampling modes of the inductive heater circuit.

18. An aerosol provision device comprising the apparatus according to claim 17.

19. The aerosol provision device of claim 18 comprising a plurality of resonant circuits.

20. (canceled)

21. (canceled)

22. An aerosol provision system comprising the aerosol provision device of claim 18, and an article comprising an aerosol generating material.

23. (canceled)

24. A method of generating aerosol comprising: providing an aerosol provision system according to claim 22, and at least partially inserting the aerosol generating article into the chamber.

25. (canceled)
